(19) United States
(12) Patent Application Publication
(10) Pub. No.: US 2005/0157172 A1
(43) Pub. Date: Jul. 21, 2005

(54) Video signal processor

(76) Inventors: Richard Hartley, Epping (GB); Stephen George Nunney, Chesham Bois (GB)

Correspondence Address: David P Gordon, 65 Woods End Road, Stamford, CT, 06905, US

(21) Appl. No.: 10/800,474

(22) Filed: Mar. 15, 2004

(30) Foreign Application Priority Data
Jan. 21, 2004 (GB) 0401441.1

(51) Int. Cl. H04N 7/01

(52) U.S. Cl. 348/186; 348/581

(57) ABSTRACT

A video signal processor receives an input video signal of a first (lower) definition and processes this to provide a picture component signal that represents a picture of reduced size. The input video signal is also processed to provide a measurement component signal that represents a graphical representation of at least one characteristic associated with the input video signal. A video signal generator generates a background video signal of a second (higher) definition. The picture component signal, measurement component signal and background video signal are all combined to provide an output video signal of the second definition.

### BACKGROUND OF THE INVENTION

1. Field of the Invention

The present invention relates to a video signal processor for providing the display, on a monitor screen, of both a video picture and at least one graphical representation of an associated signal characteristic, such as a video waveform, a vector diagram, an audio level display and an audio phase display.

2. State of the Art

Video signal processors are known in which a normal definition video signal is processed in order to provide a display of the video picture on part of a monitor screen, and graphical representations of associated signal characteristics on other parts of the same monitor screen. Typically the picture is displayed in one quarter of the screen, whilst a video waveform is displayed in a second quarter of the screen, a vector diagram is displayed in a third quarter of the screen, and audio level and phase information is displayed in graphical form in a fourth quarter of the screen.

Where the normal definition video signal is processed for display on a normal definition monitor, because the picture is displayed at a quarter of its original size, it is displayed at a reduced resolution. The alternative is to process the normal definition video signal for display on a high resolution computer monitor: this preserves the original picture resolution but the interlaced fields of the incoming normal definition video signal must be de interlaced for display on the computer monitor and this creates undesirable artifacts in the processed signal and accordingly in the display.

### SUMMARY OF THE INVENTION

In accordance with the present invention, there is provided a video signal processor which comprises an input for receiving an input video signal of a first definition, resizing means for processing the input video signal to provide a picture component signal corresponding thereto, analyzing means for processing the input video signal to provide a measurement component signal representing a graphical representation of at least one characteristic associated with the input video signal, a video signal generator for generating a background video signal of a second definition, and means for combining the picture component signal and the measurement component signal into the background video signal to provide an output video signal of the second definition.

The signal processor is accordingly able to process a normal definition video signal for the display of the picture in part of a high definition monitor screen, whilst displaying, in another part of the screen, a graphical representation of at least one characteristic of the video signal.

Preferably, the video signal processor is arranged so that the picture will be displayed in one quarter of the monitor screen, with a video waveform, a vector diagram and audio information displayed in the other quarters of the screen.

Preferably, the input video signal (normal definition) will consist of a first plurality of horizontal lines (e.g. 625 lines) made up of two interlaced fields, and the output video signal (high definition) will consist of a greater number of horizontal lines (e.g. 1125 lines) made up of two interlaced fields.

It will be appreciated that the picture as displayed on the high definition monitor screen will, despite its reduced size, maintain its normal resolution.

Additional objects and advantages of the invention will become apparent to those skilled in the art upon reference to the detailed description taken in conjunction with the provided figures.

### BRIEF DESCRIPTION OF THE DRAWINGS

FIG. 1 shows a display device that displays a multi-part video signal provided by a video signal processor; and

FIG. 2 is a block diagram of a video signal processor in accordance with the present invention.

FIG. 3 is a block diagram of an exemplary video signal processor in accordance with the present invention.

### DETAILED DESCRIPTION OF THE PREFERRED EMBODIMENTS

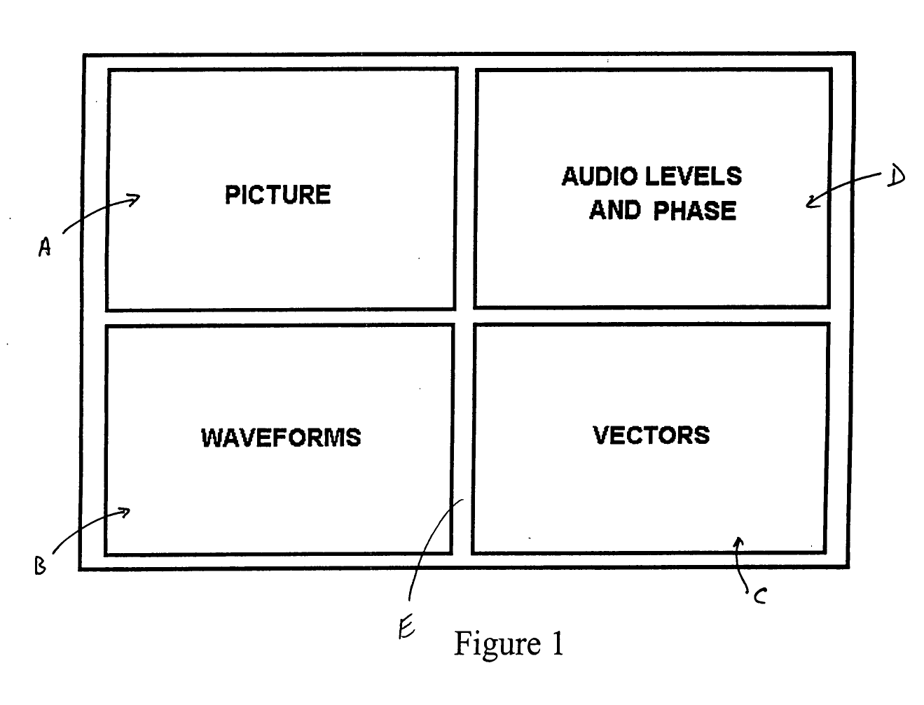

Referring to FIG. 1 of the drawings, a video signal processor typically process an incoming video signal to generate an output video signal which creates a multi-part display on a monitor screen, which includes four quarters as shown. In one quarter A, the incoming video signal is displayed. In a second quarter B, one or more video waveforms are displayed. In a third quarter C, one or more vector diagrams are displayed. In the fourth quarter D, audio level and audio phase information is displayed in graphical form.

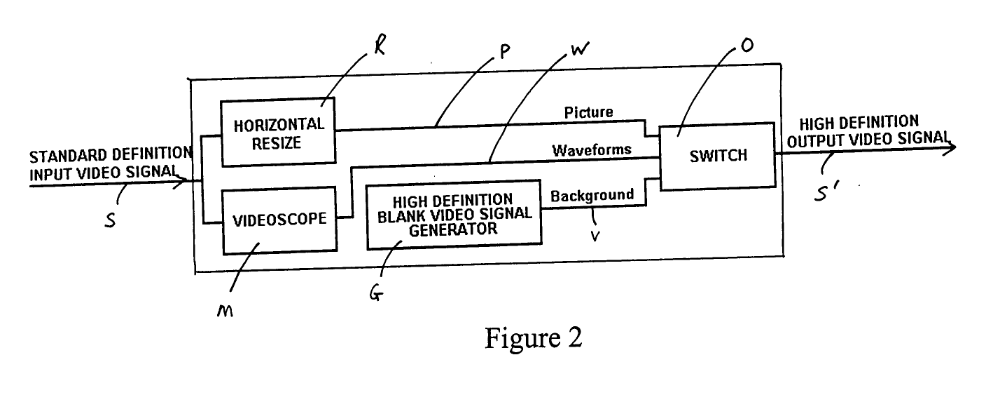

Referring to FIG. 2, a video signal processor in accordance with the present invention processes an incoming video signal S with standard definition to provide an output video signal S′ with high definition that suitable for display on a high definition display device in a manner shown in FIG. 1. Such standard definition video signals typically provide interlaced fields of 625 (or 525) horizontal lines per field at the desired field rate. For example, the standard definition video signal S may have a PAL format having 625 interlaced horizontal lines per field (e.g., two interlaced fields of 312.5 lines each) at a 50 HZ field rate. The standard definition video signal may also have an NTSC format having 525 interlaced horizontal lines per field (e.g., two interlaced fields of 262.5 lines each) at a 60 Hz field rate. These exemplary standard definition video signal formats are supported by a wide variety of commercially available standard definition televisions and other standard definition video display devices.

The high definition output video signal S′ produced by the video signal processor has a high definition format that is suitable to drive a progressive scan (i.e., non-interlaced) display device at a resolution more than 600 lines per field at a desired field rate (typically 50 Hz or 60 Hz), or is suitable to drive an interlaced scan display device at a resolution of more than 1000 lines per field at a desired field rate. The high definition output video signal S′ may have a high definition format of 1125 interlaced horizontal lines per field (e.g., two interlaced fields of 562.5 lines each) at a desired field rate (typically 50 Hz or 60 Hz). In another example, the high definition output video signal S′ may have a high definition format of 1080 interlaced horizontal lines per field (e.g., two interlaced fields of 540 lines each) at a desired field rate (typically 50 Hz or 60 Hz). In yet another example, the high definition output video signal S′ may have a high definition format of 720 progressive horizontal lines per field (e.g., each field includes 720 lines) at a desired field rate (typically 50 Hz or 60 Hz). In yet another example, the high definition output video signal S′ may have a high definition format of 1080 progressive horizontal lines per field (e.g., each field includes 1080 lines) at a desired field rate (typically 50 Hz or 60 Hz). These exemplary high definition video signal formats are supported by a wide variety of commercially available high definition televisions and other high definition video display devices.

The video signal processor includes a video signal generator G which generates a background signal V of high definition format (i.e. 1125 horizontal lines made up of two interlaced fields of 562.5 lines each). Preferably, the high definition background signal V comprises a blanking (e.g., black) video signal.

The video signal processor further comprises a resizing circuit R which receives the standard resolution incoming video signal S and processes the input video signal S to provide a picture component signal P, which represents a reduced-size (i.e. quarter size) picture corresponding to the incoming video signal S. The processor also comprises a signal measurement or analysis circuit M which also receives the incoming video signal S and, from this, derives a measurement (or analysis) signal W which represents a video waveform, vector diagram and audio information display. Details of circuitry suitable for realizing the resizing circuit R and the signal measurement circuit M are set forth in detail in U.S. Pat. Nos. 5,166,791 and 6,069,607 as well as UK Patent Application GB2183420, incorporated by reference herein in their entirety.

The video signal processor further comprises an output circuit O which combines the component signals V, P and O (by superimposing the picture component signal P and measurement signal O onto the high definition background signal V) to form the output video signal S′ with high definition.

In use, the output video signal S′ is fed to a high definition display device to create a display of the form shown in FIG. 1. The picture (derived from the picture component signal P) is displayed of reduced (quarter) size, but it will be appreciated that its resolution will be maintained, and will correspond with the resolution of the picture created had the incoming video signal S been fed directly to a lower definition display device, for display of the picture full-size on that lower-definition display device.

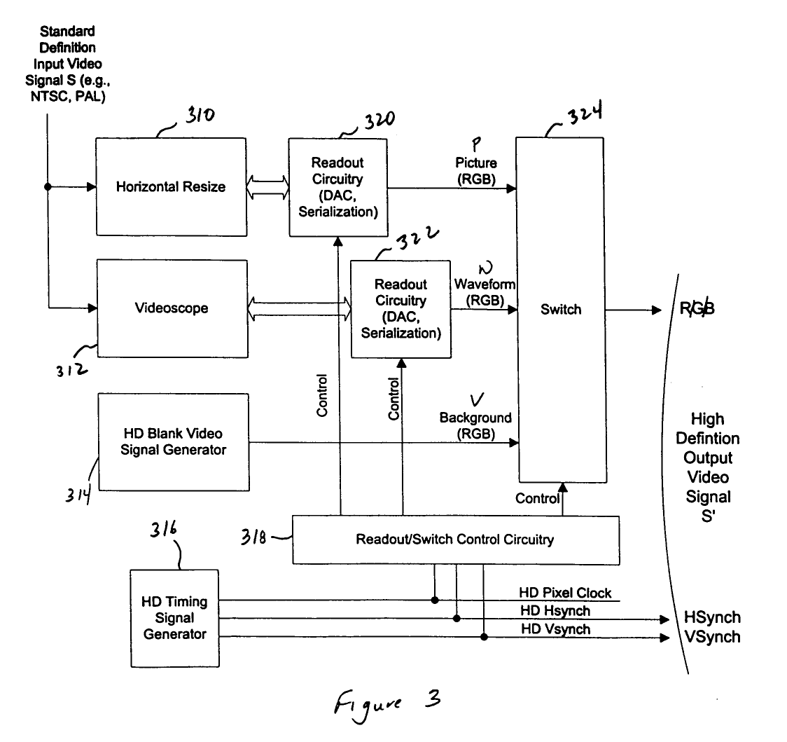

FIG. 3 is a block diagram illustrating an exemplary embodiment of the video signal processor of FIG. 2. It includes resize circuitry 310 that receives the standard resolution input video signal S and processes the input video signal S to generate and store a picture component signal P, which includes an array of RGB pixel data values that represent a reduced-size (i.e. quarter size) picture corresponding to the incoming video signal S. The video signal processor also comprises a signal measurement circuit 312 which also receives the standard resolution video signal S and, from this, derives and stores a waveform component signal W, which includes separate arrays of RGB pixel data values that represent a video waveform, a vector diagram and audio information display, respectively. Details of circuitry suitable for realizing the resizing circuitry 310 and the signal measurement circuit 312 are set forth in detail in U.S. Pat. Nos. 5,166,791 and 6,069,607 as well as UK Patent Application GB2183420, incorporated by reference above in their entirety.

The video signal processor includes a video signal generator 314 that generates a background signal V of high definition format (i.e. 1125 horizontal lines made up of two interlaced fields of 562.5 lines each). Preferably, the high definition background signal V comprises a blanking video signal (e.g., an RGB signal representing a blank (or black) color level).

A high definition timing signal generator 316 generates timing signals that are used to scan/display a high definition video signal on a high resolution display device. These timing signals include a high definition pixel clock signal which represents transitions between pixels in the high definition video signal, a high definition horizontal synchronization signal which represents transitions between lines in the high definition video signal, and a high definition vertical synchronization signal that represents transitions between fields in the high definition video signal.

The timing signals generated by the timing signal generator 316 are provided to control circuitry 318, which analyzes these timing signals to ascertain if such signals correspond to particular portions of a high resolution display frame as follows. In the event that such timing signals correspond to a portion of a high resolution display frame in the top-left quadrant A, the control circuitry 318 cooperates with readout circuitry 320 and switch 324 to read out the picture component signal P generated and stored by the resize circuitry 310 for output as part of the high definition output video signal S′. In the event that such timing signals correspond to a portion of a high resolution display frame in the bottom-left quadrant B, the control circuitry 318 cooperates with readout circuitry 322 and switch 324 to read out the waveform image signal generated and stored by the measurement circuitry 312 for output as part of the high definition output video signal S′. In the event that such timing signals correspond to a portion of a high resolution display frame in the bottom-right quadrant C, the control circuitry 318 cooperates with readout circuitry 322 and switch 324 to read out the vector waveform signal generated and stored by the measurement circuitry 312 for output as part of the high definition output video signal S′. In the event that such timing signals correspond to a portion of a high resolution display frame in the top-right quadrant D, the control circuitry 318 cooperates with readout circuitry 322 and switch 324 to read out the audio information signal generated and stored by the measurement circuitry 312 for output as part of the high definition output video signal S′. Finally, in the event that such timing signals correspond to portions of a high resolution display frame outside the intended display areas in these four quadrants (such portions are labeled E in FIG. 1), the control circuitry 318 cooperates with the switch 324 to read out the background video signal generated by the signal generator 314 for output as part of the high definition output video signal S′. In this manner, the high definition component signals (e.g., RGB signals) produced at the output of the switch 324 together with high definition timing components produced by the timing signal generator 316 provide the high definition output video signal S′, which is suitable for display on a high definition display device to create a display of the form shown in FIG. 1. Such control operations multiplex the picture component signal, the waveform/audio/vector displays and the background signal together to form the high resolution output video signal S′ whereby the picture component signal and the waveform/audio/vector displays are superimposed onto background signal to create a display of the form shown in FIG. 1.

In the illustrative embodiment shown in FIG. 3, the high resolution output video signal S′ is represented by five distinct analog waveforms (R/G/B component waveforms and Hsynch/Vsynch timing waveforms). Alternatively, other high resolution analog signal formats, such as YPbPr and DVI-Analog, may be used. In these embodiments, the readout circuits 320, 322 perform digital-to-analog conversion and serialization of the digital pixel data values generated and stored by the resize circuitry 310 and measurement circuit 312, respectively. In alternative embodiments, the high resolution output video signal S′ may be represented by a high resolution digital signal format, such as DVI-Digital or HDMI. In these embodiments, the readout circuitry 320, 322 need not digital-to-analog conversion as the pixel data is carried in digital form.

There have been described and illustrated herein an embodiment of a video signal processor in accordance with the present invention. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

1. A video signal processor comprising:
an input that receives an input video signal of a first definition;
resizing circuitry, operably coupled to said input, that processes said input video signal to provide a picture component signal corresponding thereto;
analysis circuitry, operably coupled to said input, that processes said input video signal to provide a measurement component signal representing a graphical representation of at least one characteristic associated with said input video signal;
a video signal generator that generates a background video signal of a second definition; and
combining circuitry, operably coupled to said resizing circuitry, said analysis circuitry and said video signal generator, that superimposes said picture component signal and said measurement component signal onto said background video signal to provide an output video signal of the second definition.

2. A video signal processor as claimed in claim 1, wherein:
the first definition of said input video signal is lower than the second definition of said background video signal and of said output video signal.

3. A video signal processor as claimed in claim 1, wherein:
the first definition comprises a first plurality of horizontal lines per frame and the second definition comprises a second plurality of horizontal lines per frame different from the first plurality of horizontal lines per frame.

4. A video signal processor as claimed in claim 3, wherein:
the first plurality of horizontal lines per frame is less than the second plurality of horizontal lines per frame.

5. A video signal processor as claim in claim 4, wherein:
the first plurality of horizontal lines per frame comprises 625 horizontal lines per frame and said second plurality of lines per frames comprises 1125 horizontal lines per frame.

6. A video signal processor as claimed in claim 2, wherein:
said output video signal represents a high definition picture suitable for display on a high definition display screen.

7. A video signal processor as claimed in claim 6, wherein:
said picture component signal represents a reduced-size picture suitable for display on part of the high definition display screen.

8. A video signal processor as claimed in claim 1, wherein:
said output video signal provides for display of a reduced-size picture represented by the picture component signal in one quarter of a display screen, a video waveform in a second quarter of the display screen, a vector diagram in a third quarter of the display screen, and audio information in a further quarter of the display screen, and
wherein said video waveform, said vector diagram and said audio information represent characteristics of said input video signal.

9. A video signal processor which comprises an input for receiving a video signal of a first definition, resizing means for processing said input video signal to provide a picture component signal for creating a picture display of reduced size, analyzing means for processing said input video signal to provide a measurement component signal for creating a display of a graphical representation of at least one characteristic associated with said input video signal, a video signal generator for generating a video signal of a second definition for providing a background display, and means for combining said picture component signal, said measurement component signal and said video signal of the second definition, to provide an output video signal.

10. A video signal processor as claimed in claim 9 arranged to receive a said video input of a relatively low definition and said video signal generator is arranged to generate a video signal of relatively high definition.

11. A video signal processor as claimed in claim 9, in which said output video signal serves for the display of the picture in one part of a display screen and a said graphical representation in another part of said screen.

12. A video signal processor as claimed in claim 9, in which said output video signal serves for the display of the picture in one quarter of a display screen, a video waveform in a second quarter of said screen, a vector diagram in a third quarter of said screen, and audio information in a fourth quarter of said screen, said video waveform, vector diagram and audio information being respective said characteristics associated with said input video signal.

13. A video signal processor which comprises an input for receiving a video signal arranged for the display on a screen of a picture comprising a first plurality of horizontal lines per frame, resizing means for processing said input video signal to provide a picture component signal for the display on said screen of a said picture of reduced size, analyzing means for processing said input video signal to provide a measurement component signal for the display of a graphical representation of at least one characteristic associated with said input video signal, a video signal generator for generating a video signal for providing a background display and comprising a second plurality of horizontal lines per frame, and means for combining said picture component signal, said measurement component signal and said video signal generated by said video signal generator, to provide an output video signal.
